(19) United States
(12) Patent Application Publication
(10) Pub. No.: US 2026/0229082 A1
(43) Pub. Date: Aug. 6, 2026

(54) CYCLIC ROTARY DISPENSING DEVICE AND VENDING DEVICE HAVING SAME

(71) Applicants: Ou Jin, Changsha (CN); Yuxin Jin, Changsha (CN)

(72) Inventors: Xiaorong Fu, Wenzhou (CN); Ou Jin, Changsha (CN); Yuxin Jin, Changsha (CN)

(21) Appl. No.: 19/634,010

(22) Filed: Mar. 30, 2026

Related U.S. Application Data
(63) Continuation-in-part of application No. 18/458,169, filed on Aug. 30, 2023, now Pat. No. 12,612,252.
(63) Continuation of application No. PCT/CN2022/110349, filed on Aug. 4, 2022.

(30) Foreign Application Priority Data
Aug. 19, 2021 (CN) 202110953807.7

(51) Int. Cl. G07F 11/24; B65G 1/137

(52) U.S. Cl. CPC G07F 11/24; B65G 1/137

(57) ABSTRACT

A tray includes multiple product boxes, configured to store products; a mounting base, provided with a closed bent slideway; and a transport assembly, including multiple mounting members, multiple connecting members and a rotating member. The mounting members are rotatably and sequentially disposed in the closed bent slideway. Each mounting member is slidably connected to the mounting base. Each product box is mounted on one side of the mounting member. The mounting members are arranged in one-to-one correspondence with the product boxes. Each connecting member is disposed between two adjacent mounting members, with two ends thereof being rotatably connected to the two adjacent mounting members respectively to maintain a distance between the mounting members. The rotating member is disposed on the mounting base, located on a side of the mounting members away from the product boxes, and in transmission connection with the mounting members to drive the mounting members to rotate.

### CROSS-REFERENCE TO RELATED APPLICATIONS

This application is a continuation-in-part of U.S. patent application Ser. No. 18/458,169, which is a continuation of International Application No. PCT/CN2022/110349, filed on Aug. 4, 2022. The International Application claims priority from Chinese patent application No. 202110953807.7, filed on Aug. 19, 2021, which is hereby incorporated herein by reference in its entirety.

### TECHNICAL FIELD

The disclosure relates to the technique field of new vending machines, and more particularly to a dispensing device with a cyclic rotary feature, which can be used not only in a vending device, but also in a display cabinet or an automatic dispensing shelf in an unmanned store.

### BACKGROUND

Dispensing devices in the related art are mainly used in a field of unmanned vending, performance of the dispensing devices is evaluated by comprehensively considering various factors such as: 1. whether the dispensing device can load more commodities in a same volume; 2. whether a cost of the dispensing device is cheap; 3. whether the dispensing device can adapt different packaging forms of the commodities.

Freight lane types (i.e., commodity passage types) of the dispensing devices in the related art include a spring freight lane, a snake-shape freight lane, a track freight lane and the like. Features of these freight lanes are that when a commodity is shipped, the commodity needs to leave the freight lane where the commodity is located and a space for the commodity to be dropped is required, which will seriously waste an inventory space.

In the related art, Chinese patent with publication NO. CN 108133545A discloses a dispensing device of a rotary discharging type automatic vending machine, a belt of the dispensing device is used to connect different dispensing units, and a commodity is driven to a specified position by a motor. The disadvantages of the above freight lanes are overcome by this dispensing device, however, there are the following disadvantages: 1. corresponding positions are occupied by a driving belt and a gear to make the dispensing device occupy a large space; 2. the dispensing device is limited by the belt, resulting in a belt layout that can only be a quasi-circular structure, a dispensing quantity of the dispensing device is greatly limited; 3. the dispensing device is driven by the belt, resulting in a higher cost.

Based on that, it is necessary to provide a new dispensing device and a vending device to overcome the above disadvantages.

### SUMMARY

Aiming at the above disadvantages of the related art, the disclosure provides a tray, including multiple product boxes, a mounting base, and a transport assembly. The multiple product boxes are configured to store products. The mounting base is provided with a closed bent slideway. The transport assembly includes multiple mounting members, multiple connecting members and a rotating member. The multiple mounting members are rotatably and sequentially disposed in the closed bent slideway in a circulating manner. Each mounting member is slidably connected to the mounting base. Each product box is mounted on one side of a corresponding one mounting member. The multiple mounting members are arranged in one-to-one correspondence with the multiple product boxes. Each connecting member is disposed between two adjacent mounting members in the closed bent slideway, with two ends thereof being rotatably connected to the two adjacent mounting members respectively. The multiple connecting members are configured to maintain a distance between the multiple mounting members. The rotating member is disposed on the mounting base, and is located on a side of the multiple mounting members facing away from the multiple product boxes. The rotating member is in transmission connection with the multiple mounting members. The rotating member is configured to drive the multiple mounting members to rotate.

In second aspect, the disclosure provides a tray assembly, including multiple trays as described above. The tray assembly further includes a tray bracket. The multiple trays are mounted on the tray bracket in sequence. The tray bracket includes movable rails, mounted on two opposite sides of the tray bracket, and configured to be slidingly connected to an external structure.

In third aspect, the disclosure provides a vending device, including multiple tray assemblies as described above. The vending device further includes a frame. The multiple tray assemblies are disposed on the frame in sequence along a vertical direction, and each tray assembly is slidably connected to the frame to form a pull-out structure.

The disclosure provides a tray, a tray assembly, and a vending device. The tray includes multiple product boxes, a mounting base, and a transport assembly. In the disclosure, the multiple product boxes store products, the mounting base is provided with a closed bent slideway, and the transport assembly includes multiple mounting members, multiple connecting members, and a rotating member. The multiple mounting members are sequentially and rotatably disposed in the closed bent slideway in a circulating manner, and each mounting member is slidably connected to the mounting base. Each product box is mounted on one side of a corresponding one mounting member, and the mounting members are arranged in one-to-one correspondence with the product boxes. The rotating member is disposed on the mounting base, and located on a side of the mounting members facing away from the product boxes. The rotating member is in transmission connection with the mounting members to drive the mounting members to rotate, so that the mounting members can drive the product boxes to circulate within the closed bent slideway. Meanwhile, by providing the connecting member between two adjacent mounting members, with two ends of the connecting member being rotatably connected to the two adjacent mounting members respectively, the disclosure ensures that the adjacent mounting members maintain a constant distance therebetween during sliding, thereby fixing the relative positions of two adjacent product boxes. This prevents the spacing between the product boxes from increasing or decreasing during rotation, ensures that the spacing between all product boxes remains constant as they move along the closed bent slideway, adapts to the limiting function and circulating movement path of the closed bent slideway, improves the synchronization of movement of the product boxes, ensures smooth circulating movement, protects the product boxes and the products carried therein, and reduces loss.

### BRIEF DESCRIPTION OF DRAWINGS

FIG. 1 illustrates a schematic structural diagram of a dispensing device according to an embodiment of the disclosure.

FIG. 2 illustrates a partial schematic structural diagram of the dispensing device according to an embodiment of the disclosure.

FIG. 3 illustrates a partial schematic structural diagram of a dispensing device according to another embodiment of the disclosure.

FIG. 4 illustrates a schematic structural diagram of a rotary pulling piece of the dispensing device according to an embodiment of the disclosure.

FIG. 5 illustrates a schematic structural diagram of a dispensing assembly of the dispensing device according to an embodiment of the disclosure.

FIG. 6 illustrates a schematic structural diagram of a vending device according to a first embodiment of the disclosure.

FIG. 7 illustrates a schematic structural diagram of a vending device according to a second embodiment of the disclosure.

FIG. 8 illustrates a schematic structural diagram of a vending device according to a third embodiment of the disclosure.

FIG. 9 illustrates a three-dimensional diagram of a tray according to an embodiment of the disclosure.

FIG. 10 illustrates another three-dimensional diagram of the tray according to the embodiment of the disclosure.

FIG. 11 illustrates a partial schematic diagram of the tray according to the embodiment of the disclosure.

FIG. 12 illustrates a partial schematic diagram of a tray according to another embodiment of the disclosure.

FIG. 13 illustrates another partial schematic diagram of the tray according to the embodiment of the disclosure.

FIG. 14 illustrates another partial schematic diagram of the tray according to another embodiment of the disclosure.

FIG. 15 illustrates a schematic structural diagram of a product box of the tray according to the embodiment of the disclosure.

FIG. 16 illustrates a schematic structural diagram of a rotating member and a power assembly of the tray according to the embodiment of the disclosure.

FIG. 17 illustrates a schematic structural diagram of a rotating member and a power assembly of the tray according to another embodiment of the disclosure.

FIG. 18 illustrates a schematic diagram of the rotating member of the tray according to the embodiment of the disclosure.

FIG. 19 illustrates a schematic diagram of a closed bent slideway of the tray according to an embodiment of the disclosure.

FIG. 20 illustrates a schematic diagram of a closed bent slideway of the tray according to another embodiment of the disclosure.

FIG. 21 illustrates a three-dimensional diagram of a tray assembly according to an embodiment of the disclosure.

FIG. 22 illustrates a three-dimensional diagram of a tray bracket of the tray assembly according to the embodiment of the disclosure.

FIG. 23 illustrates a three-dimensional diagram of a vending device according to an embodiment of the disclosure.

FIG. 24 illustrates a partial schematic diagram of the vending device according to the embodiment of the disclosure.

FIG. 25 illustrates a partial schematic diagram of a vending device according to another embodiment of the disclosure.

### DETAILED DESCRIPTION OF EMBODIMENTS

The following provides a detailed description of the disclosure in conjunction with embodiments. The following embodiments are conducive to further understand the disclosure for those skilled in the art, but do not limit the disclosure in any form. It should be pointed that multiple deformations and improvements can be made without departing from a concept of the disclosure for those skilled in the art and are all within a scope of protection of the disclosure.

In description of the disclosure, it should be understood that terms “center”, “longitudinal”, “transverse”, “length”, “width”, “thickness”, “up”, “down”, “front”, “back”, “left”, “right”, “vertical”, “horizontal”, “top”, “bottom”, “inner”, “outer”, “clockwise”, “anticlockwise”, and the like indicate orientation or positional relationships based on the orientation or positional relationships shown in drawings and are intended merely to facilitate the description of the disclosure, not to indicate or imply that the device or element referred thereto must have a particular orientation or be constructed and operated in a particular orientation, and therefore are not to be construed as limiting the disclosure.

Moreover, terms “first”, and “second” are merely used to describe purposes, cannot be understood to indicate or imply relative importance or implicitly indicate the number of indicated technical features. Thus, features defined with “first” and “second” can explicitly or implicitly include one or more of the features. In description of the disclosure, unless otherwise specified, a meaning of “multiple” is two or more.

In the disclosure, unless otherwise specified and limited, the terms “install”, “couple”, “connect”, “fix” and other terms should be understood in a broad sense. For example, the term “connect” can be a fixed connection, a detachable connection, or an integrally formed; it can be a mechanical connection, an electrical connection, or in communication with each other; It can be a direct connection or an indirect connection through an intermediate medium, which can be an internal communication between two components or an interaction relationship between two components, unless otherwise specified. For those skilled in the art, the specific meanings of the above terms in the disclosure can be understood based on specific circumstances.

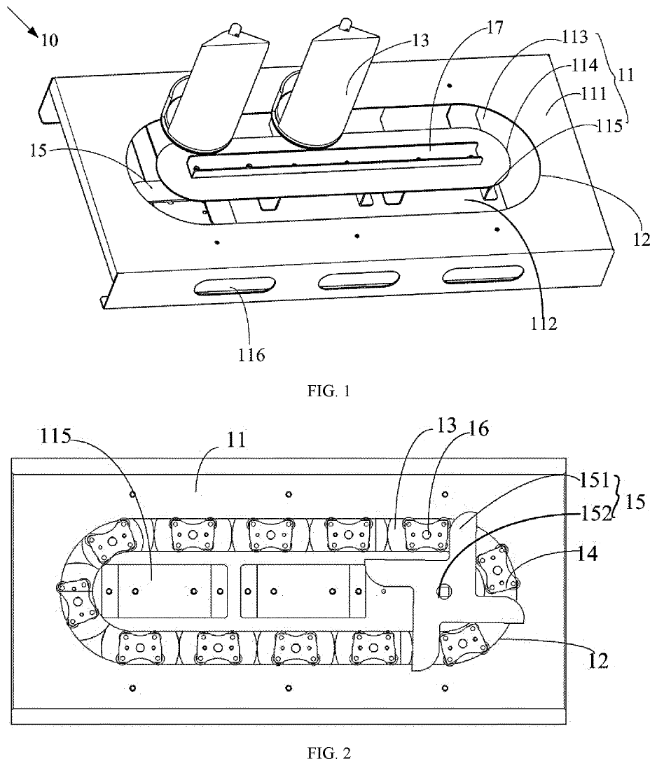

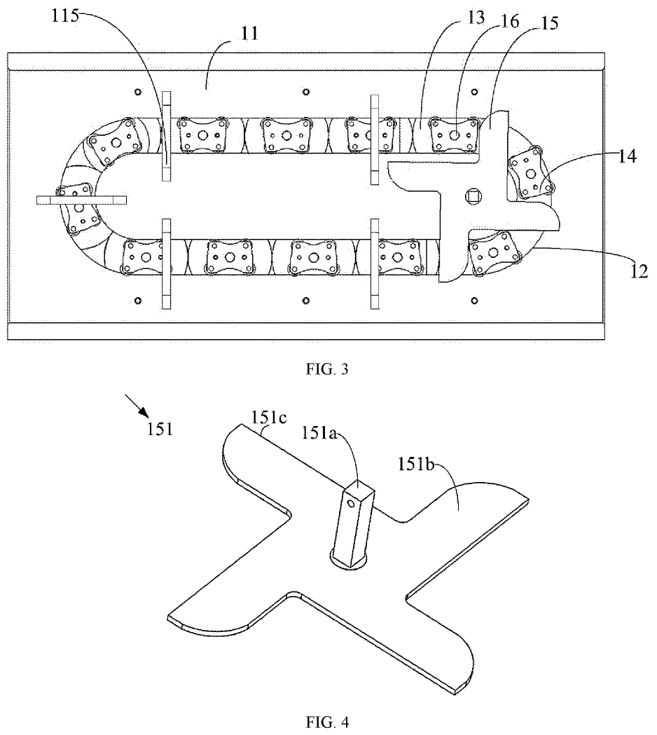

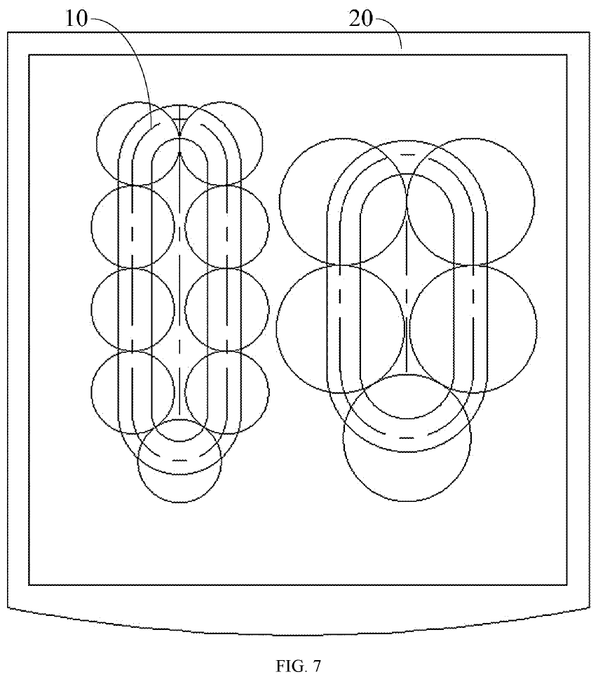

Referring to FIGS. 1-7, the embodiments are provided in the disclosure.

The disclosure provides a cyclic rotary dispensing device, the dispensing device 10 includes a housing 11, a closed bent slideway 12, multiple dispensing assemblies 13, a driving assembly 15 and a first detection assembly. The closed bent slideway 12 is disposed on the housing 11. The multiple dispensing assemblies 13 are disposed along the closed bent slideway 12 and abutted against each other, and a bottom of each of the dispensing assemblies 13 is provided with a protrusion 16. The driving assembly 15 is disposed below the closed bent slideway 12, and the driving assembly 15 includes a rotary pulling piece 151 and a driving member 152. The rotary pulling piece 15 is disposed below the closed bent slideway 12, and the driving member 152 is configured to drive the rotary pulling piece 151 to rotate, and the rotary pulling piece 151 is configured to rotate to drive the protrusion 16 to move, to thereby make the dispensing assemblies 13 cyclically move along the closed bent slideway 12. The first detection assembly is disposed below the closed bent slideway 12. The driving assembly 15 is configured to drive the dispensing assemblies 13 to cyclically dispense along the closed bent slideway 12. The dispensing assemblies 13 are tightly arranged along the closed bent slideway 12 in sequence, the driving assembly 15 is configured to drive one of the dispensing assemblies 13 to slide forward along the closed bent slideway 12, other dispensing assemblies 13 are squeezed to slide forward in sequence, and efficiency for selling is improved by multiple cyclic moving dispensing assemblies 13.

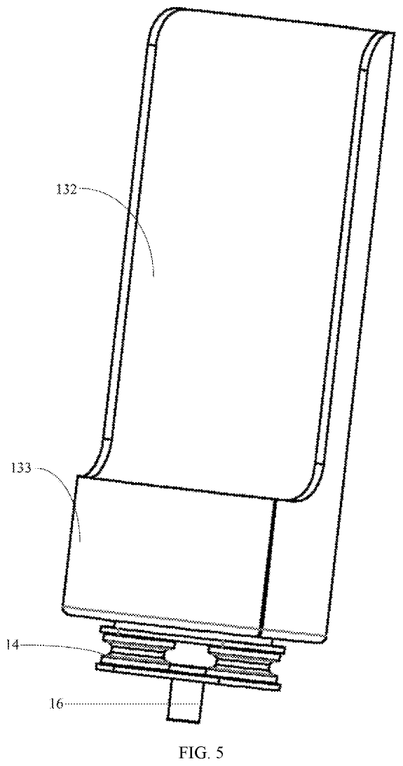

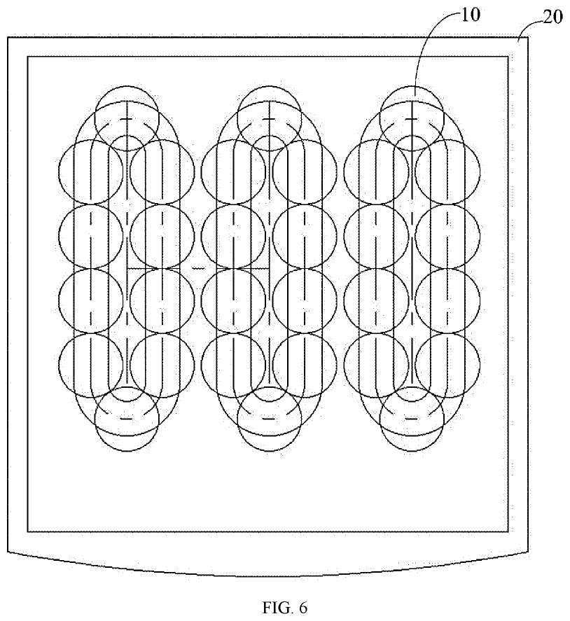

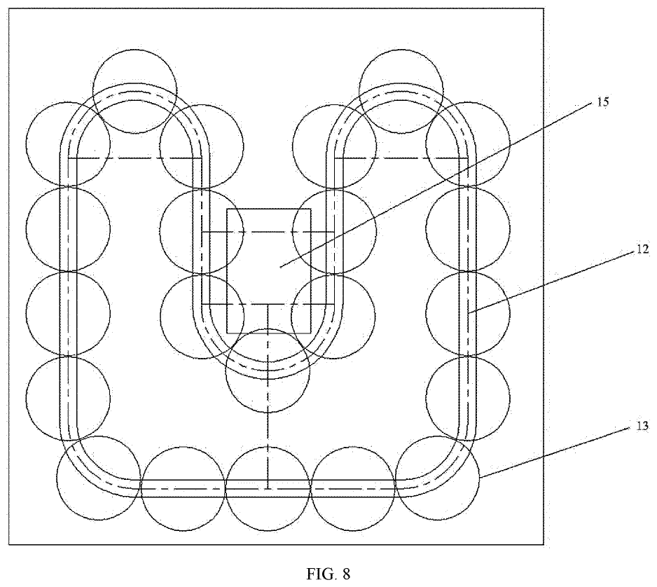

In the embodiment, referring to FIGS. 5-7, the closed bent slideway 12 is a closed bent slideway, a shape of the closed bent slideway 12 is not limited to a circle, a runway ring, an ellipse, a square, a quasi-circular structure, or a combination of the above shapes, and the shape of the closed bent slideway 12 can be designed according to actual needs of structures of a pallet and a shelf of a vending device. As shown in FIG. 8, the driving assembly 15 is disposed at an inward depression of the closed bent slideway 12, a rigidity of the closed bent slideway 12 itself is used, and the closed bent slideway 12 is tightly filled with the dispensing assemblies 13, so as to greatly overcome a disadvantage of using a belt structure in the related art, the cyclic rotary dispensing device has a simple and reliable structure, and a capacity of the cyclic rotary dispensing device is significantly expanded.

The dispensing device of the embodiment can be used not only in a vending device, but also in a display cabinet or an automated dispensing shelf in an unmanned store.

The first detection assembly of the disclosure is configured to detect a dispensing position of the dispensing assemblies. Specifically, the first detection assembly is a position detection sensor, such as a photoelectric sensor. The position detection sensor is fixed on the housing 11, and the position detection sensor is disposed below the dispensing assemblies 13. When the dispensing assemblies 13 are moved under a drive of the driving assembly 15 on a closed loop (i.e., closed bent slideway 12), one of the dispensing assemblies 13 is moved to a detection position of the position detection sensor, a command is given by the position detection sensor to stop a motor and wait for pickup.

Referring to FIGS. 1-3, in an embodiment, the housing 11 includes a first groove body 111, a closed bent through-hole 113, an inner plate 114 and a support member 115. An upper surface of the first groove body 111 defines the closed bent through-hole 113. The inner plate 114 is disposed in the closed bent through-hole 113, and an inner wall of the closed bent through-hole 113 is opposite to an outer wall of the inner plate 114. The support member 115 is disposed on a lower surface of the first groove body 111, and the support member 115 is fixedly connected to the inner plate 114 and the first groove body 111. An end of the support member 115 is fixedly connected to the first groove body 111, another end of the support member 115 is fixedly connected to the inner plate 114, and the support member 115 defines a space for the protrusion 16 to pass through. An upper surface of the first groove body 111 and an upper surface of the inner plate 114 are located in a same plane, the inner wall of the closed bent through-hole 113 is provided with an outer rail of the closed bent slideway 12, and the outer wall of the inner plate 114 is provided with an inner rail of the closed bent slideway 12, a guide pulley 14 of the dispensing assembly 13 is configured to move along guide directions of the inner rail and the outer rail, prevent an oscillation of the dispensing assemblies 13 during movement, and ensure stability during dispensation.

In another embodiment, the housing 11 includes the first groove body 111, a second groove body 112, the closed bent through-hole 113, the inner plate 114 and the support member 115. The second groove body is detachably connected to the first groove body 111, the upper surface of the first groove body 111 defines the closed bent through-hole 113, the inner plate 114 is disposed in the closed bent through-hole 113 and the inner wall of the closed bent through-hole 113 is opposite to the outer wall of the inner plate 114. An end of the support member 115 is fixedly connected to the inner plate 114, and another end of the support member 115 is fixedly connected to the second groove body 112. The first groove body 111 is opposite to the second groove body 12, the first groove body 111 and the second groove body 112 are formed by using a steel plate bending forming or a stamping forming, and the steel plate bending forming or the stamping forming has a low cost and is easy to make. The first groove body 111 is fixedly connected to the second groove body 112 by the support member 115 disposed between the first groove body 111 and the second groove body 112, and the support member 115 is fixedly connected to the first groove body 111 and the second groove body 112 by bolts. The inner plate 114 is installed on an upper surface of the support member 115, and the inner plate 114 is disposed inside the closed bent through-hole 113 of the first groove body 111, a space for holding the driving assembly 15 is defined between the first groove body 111 and the second groove body 112, a structure of the dispensing device is compact and the structure is convenient for maintenance. Checking holes 116 are defined on the first groove body 111 for maintenance, and the checking holes 116 further have the function for heat dissipation. That is, the first groove body 111 defines multiple holes for maintenance and heat dissipation.

In an embodiment of the disclosure, the driving member 152 includes a driving motor and a speed change gearbox, and the speed change gearbox is connected to the rotary pulling piece 151. The driving motor is connected to the rotary pulling piece 151 by the speed change gearbox. Specifically, the speed change gearbox is a deceleration device, and the speed change gearbox is configured to change a speed from a high speed rotation to a low speed rotation, and the low speed rotation is a low rotational speed of the rotary pulling piece 151, thus a need for dispensing is met.

In an embodiment of the disclosure, each of the dispensing assemblies 13 is in contact with the closed bent slideway 12 by the guide pulley 14. The guide pulley 14 includes a pulley adapted to the closed bent slideway 12, the guide pulley 14 is configured to guide along the closed bent slideway 12, so as to prevent the oscillation of the dispensing assemblies 13 during movement, and ensure the stability during dispensation.

In an embodiment of the disclosure, each of the dispensing assemblies 13 includes the guide pulley 14 and a rotary drum 132, and the rotary drum 132 is disposed on the guide pulley 14, and a side of the rotary drum 132 is provided with an opening 133. Outer circumferential surfaces of adjacent guide pulleys 14 are abutted against each other, and the commodity is placed in the rotary drum 132. In an embodiment, the number of the pulley in the guide pulley 14 is two, the two pulleys are symmetrically disposed along a diameter of the rotary drum 132, and a distance between outermost diameters of the two pulleys is smaller than a width of the closed bent slideway 12, that is a distance between outermost sides of the two pulleys is smaller than the width of the closed bent slideway.

In an embodiment of the disclosure, a side of the opening of the rotary drum 132 is provided with a segment gate. The segment gate is configured to be moved up and down along the opening 133, and the segment gate is configured to rebound after leaving with the commodity in hand. And the segment gate on the side of the opening is configured to prevent the commodity from falling.

In an embodiment of the disclosure, an upper end and a bottom end of the opening 133 are provided with guide grooves, the segment gate is matched with the opening 133, the segment gate is configured to open and close the opening 133 along the guide grooves, and the segment gate is configured to automatically reset by at least one way of a tension spring reset, a pressure spring reset and a gravity hammer lifting reset.

In an embodiment of the disclosure, a side of the segment gate is hinged to a side of the opening 133.

In an embodiment of the disclosure, the rotary pulling piece 151 includes a rotary shaft 151a and pulling pieces 151b. The rotary shaft 151a is disposed on a center of the rotary pulling piece 151. The pulling pieces 151b are symmetrically disposed along the rotary shaft 151a, a side of each of the pulling pieces 151b is provided with a pulling part 151c, and another side of each of the pulling pieces facing away from the pulling part 151c is provided with an arc-shaped part. When the rotary pulling piece 151 rotates, the protrusion 16 is driven to move by the pulling part 151c of the pulling pieces 151b.

In an embodiment of the disclosure, the cyclic rotary dispensing device further includes a reinforcement block 17 disposed on the inner plate 14. Because the driving motor occupies a supporting space of the inner plate 114, a bottom of the inner plate 114 is unsupported, sinking and deformation are easy to occur, and a normal sliding for the guide pulley 14 is affected, therefore the reinforcement block 17 is configured to strengthen the strength of the inner plate 114.

The disclosure further provides a vending device, and the vending device includes a dispensing device 10, a container 20 and a center processing unit. The container 20 is provided with at least one pickup hole, a commodity on the container is taken out through the pickup hole (i.e., target pickup hole) when one of the dispensing assemblies is moved to the pickup hole. A second detection assembly is disposed on the at least one pickup hole or the dispensing assemblies 13, and the second detection assembly is a sensor, the first detection assembly (as mentioned above) is configured to determine the dispensing position of the dispensing assemblies 13, that is, when the dispensing assemblies 13 on the closed bent slideway 12 are driven by the driving motor to move to a position that can be detected by the first detection assembly, the first detection assembly send out a command to stop the driving motor and wait for pickup. Before purchasing the commodity, when one of the dispensing assemblies 13 is moved to the pickup hole, the second detection assembly is configured to determine whether the commodity in the dispensing assembly 13 exists, in a situation that the commodity exists, the driving motor is not driven, in a situation that the commodity does not exist, the driving motor is driven to the next dispensing assembly 13.

The center processing unit is electrically connected to the dispensing device 10, and both the center processing unit and the dispensing device 10 are disposed inside the container 20, and the opening 133 of the dispensing device 10 is in communication with outside.

Referring to FIGS. 5-8, the vending device includes at least one of the dispensing devices 10, a shape of the dispensing device 10 can be designed according to an actual need, not limited to a circle. A size and a shape of the closed bent slideway 12 can be flexibly selected according to the actual need, the number of the dispensing assemblies 13 can be flexibly selected according to the size of the closed bent slideway 12 and a size of the commodity. The vending device of the disclosure has advantages such as a compact structure, a large capacity, a high space utilization, and the number for dispensing is not limited.

The disclosure provides the cyclic rotary dispensing device and the vending device with the same, the vending device is provided with a cyclic rotary dispensing device in a unit structure, the dispensing device includes the housing 11, the closed bent slideway 12, the multiple dispensing assemblies 13, the driving assembly 15 and the first detection assembly. The container 20 is provided with the at least one pickup hole, the commodity on the container is taken out through the pickup hole when the dispensing assembly is moved to the pickup hole. The dispensing assemblies 13 are tightly arranged along the closed bent slideway 12 in sequence, the driving assembly 15 is configured to control one of the dispensing assemblies to slide forward along the closed bent slideway 12 according a command of the first detection assembly, other dispensing assemblies 13 in the closed bent slideway 12 are squeezed to slide forward in sequence. Specifically, disadvantages of existing methods in the related art are overcome, and the embodiments of the disclosure do not use a belt to connect the dispensing assemblies 13 in series. Meanwhile, it overcomes the problem that the dispensing device can only be a circular structure, the structure of the dispensing device can be also a winding and circuitous structure, which greatly expands a scope of use of the freight lanes. Moreover, efficiency for selling is improved by multiple cyclic moving dispensing assemblies of the disclosure, and the dispensing device has advantages such as a compact structure, a high space utilization rate, a low manufacturing cost, and convenient maintenance. The dispensing device can sell commodities with different packaging specifications and multiple types at the same time.

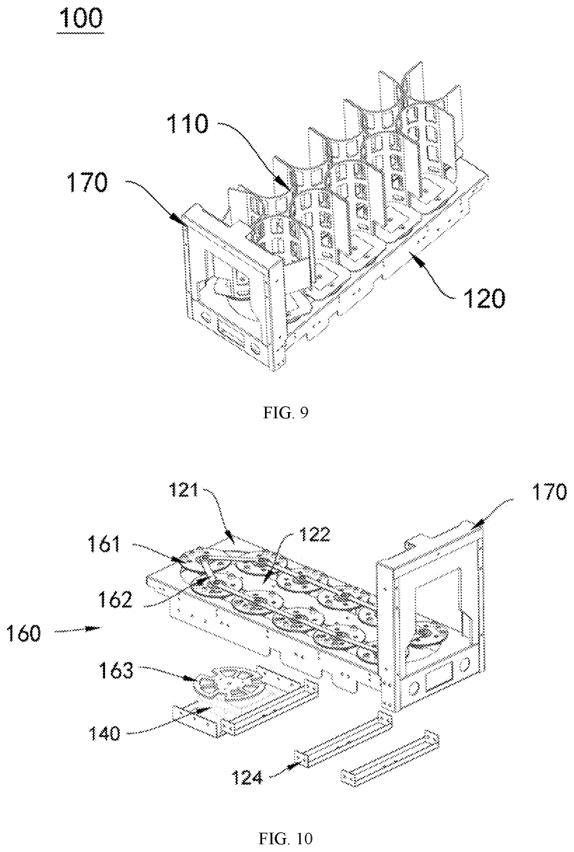

As shown in FIG. 9 and FIG. 10, the disclosure provides a tray 100, including multiple product boxes 110, a mounting seat 120 and a transport assembly 160.

The multiple product boxes 110 are configured to store products. As shown in FIG. 14, the mounting base 120 is provided with a closed bent slideway 123.

Specifically, as shown in FIG. 10, the transport assembly 160 includes multiple mounting members 161, multiple connecting members 162, and a rotating member 163.

The multiple mounting members 161 are sequentially and rotatably disposed in the closed bent slideway 123 in a circulating manner. Each mounting member 161 is slidably connected to the mounting base 120. Each product box 110 is mounted on one side of a corresponding one mounting member 161, and the mounting members 161 are arranged in one-to-one correspondence with the product boxes 110.

It should be noted that the number of the mounting members 161 in this embodiment is, for example, eleven. However, the embodiment does not limit the number of the mounting members 161, and the specific number can be designed according to actual production requirements.

Each connecting member 162 is disposed between two adjacent mounting members 161, with two ends thereof being rotatably connected to the two adjacent mounting members 161 respectively. The connecting member 162 is configured to maintain a distance between the mounting members 131.

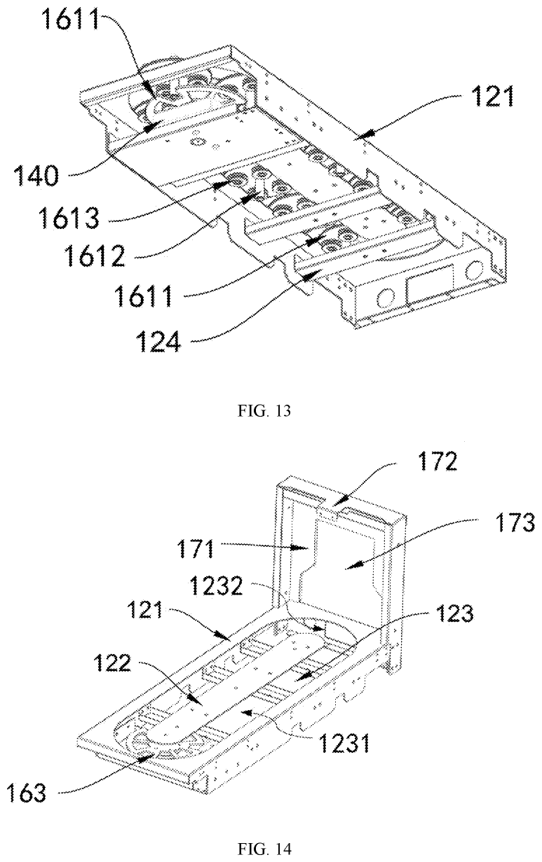

In addition, as shown in FIG. 13, the rotating member 163 is disposed on the mounting base 120, and located on a side of the mounting members 161 facing away from the product boxes 110. The rotating member 163 is in transmission connection with the mounting members 131, and is configured to drive the mounting members 131 to rotate.

In the disclosure, the disclosure provides a tray 100. The tray 100 includes multiple product boxes 110, a mounting base 120, and a transport assembly 160. In the disclosure, the multiple product boxes 110 store products, the mounting base 120 is provided with a closed bent slideway 123, and the transport assembly 160 includes multiple mounting members 161, multiple connecting members 162, and a rotating member 163. The multiple mounting members 161 are sequentially and rotatably disposed in the closed bent slideway 123 in a circulating manner, and each mounting member 161 is slidably connected to the mounting base 120. The product boxes 110 are mounted on the mounting members 161, and the mounting members 161 are arranged in one-to-one correspondence with the product boxes 110. The rotating member 163 is disposed on a side of the mounting members 161 facing away from the product boxes 110 and is in transmission connection with the mounting members 161. The rotating member 163 drives the mounting members 161 to rotate, to thereby drive the product boxes 110 to circulate within the closed bent slideway 123. Meanwhile, by providing the connecting member 162 between two adjacent mounting members 161, so that the adjacent mounting members 161 maintain a constant distance therebetween during sliding. The connecting member 162 precisely controls a spacing between adjacent product boxes 110, thereby avoiding spacing disorder that could lead to problems such as mutual squeezing, jamming, or derailment of the product boxes 110. This ensures that the spacing between all product boxes 110 remains constant as they move along the closed bent slideway 123. At the same time, the connecting member 162 connects the mounting members 161 into a rigidly linked whole, thereby improving the synchronization of movement of the product boxes 110, ensuring smooth circulation, and improving the accuracy of product dispensing and the reliability of equipment operation. Furthermore, the connecting member 162 in the embodiment effectively avoids squeezing and collision between adjacent product boxes 110, which prevents wear and damage to the product boxes 110 due to collision, while also preventing products from being crushed, deformed, or damaged, thereby protecting the product boxes 110 and the products carried therein, and reducing loss. In addition, by using the connecting members 162 to connect the multiple mounting members 161 in series, the overall stress on the series-connected mounting members 161 is more uniform, so that the rotating member 163 does not need to overcome additional loads caused by asynchronization of the mounting members 161 and the product boxes 110. This simplifies the drive control logic, reduces the energy consumption and operational load of the rotating member 163, and prolongs a service life of the rotating member 163. Moreover, by having the two ends of the connecting member 162 rotatably connected to the two adjacent mounting members 161 respectively, this embodiment ensures a constant spacing between all product boxes 110 as they move along the closed bent slideway 123 while allowing a certain degree of angular rotation between the two adjacent mounting members 161 and the connecting member 162 therebetween, further ensuring smooth and stable circulating movement of the mounting members 161 and the product boxes 110.

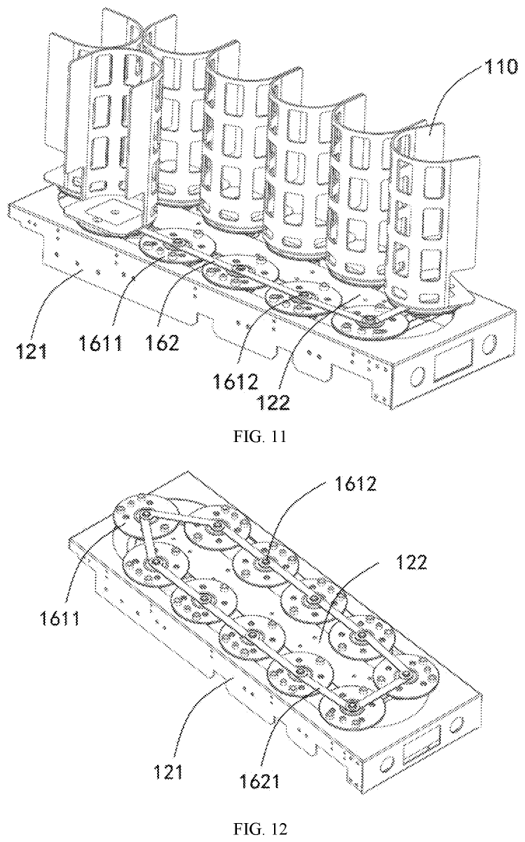

In an embodiment, as shown in FIGS. 11, 12 and 14, the mounting base 120 includes a housing 121 and an inner plate 122. The housing 121 is disposed around the inner plate 122 and forms the closed bent slideway 123 together with the inner plate 122. Optionally, the embodiment further includes support plates 124. The support plates 124 are disposed on a side of the housing 121 facing away from the product boxes 110 and are fixedly connected to the housing 121 by screws. The support plates 124 are also fixedly connected to the inner plate 122 by bolts. The support plates 124 are used to support the inner plate 122. In an embodiment, the number of the support plates 124 in this embodiment is, for example, three, and the three support plates 124 are arranged along a length direction of the inner plate 122. It should be noted that this embodiment does not limit the number of the support plates 124, and the specific number can be designed according to actual production requirements.

In an embodiment, the inner plate 122 and the closed bent slideway 123 in this embodiment are, for example, both elliptical. The rotating member 163 is disposed corresponding to a curved turning portion of the inner plate 122. In this embodiment, the rotating member 163 pushes the mounting members 161 located at the curved turning portion of the inner plate 122, thereby enabling the multiple product boxes 110 to circulate along the elliptical closed bent slideway 123.

In an embodiment, as shown in FIGS. 11-13 and 15, the mounting member 161 of this embodiment includes a mounting plate 1611 and rollers 1613.

The mounting plate 1611 is configured to mount the product box 110. A protrusion 1612 is disposed on a side of the mounting plate 1611 facing away from the product box 110. The protrusion 1612 is configured to be in transmission connection with the rotating member 163.

In addition, the rollers 1613 are disposed on the side of the mounting plate 1611 facing away from the product box 110, are rotatably connected to the mounting plate 1611 via fixing shafts, and are slidably connected to an inner sidewall of the closed bent slideway 123.

In an embodiment, each mounting plate 1611 in this embodiment is correspondingly provided with four rollers 1613, with two rollers 1613 forming a group. The four rollers 1613 are divided into two groups that are respectively positioned close to the two inner sidewalls of the closed bent slideway 123. That is, two of the rollers 1613 are in sliding contact with an inner edge of the housing 121 of the closed bent slideway 123, and the other two rollers 1613 are in sliding contact with an outer edge of the inner plate 122 of the closed bent slideway 123. It should be noted that this embodiment does not limit the number of the rollers 1613, and the specific number can be designed according to actual production requirements.

In an embodiment, as shown in FIG. 12, the connecting member 162 in this embodiment is, for example, a connecting strip 1621. The connecting strip 1621 is disposed on the side of the mounting plate 1611 close to the product box 110. The connecting strip 1621 connects two adjacent mounting plates 1611. One end of the connecting strip 1621 is rotatably connected to one of the mounting plates 1611, and the other end of the connecting strip 1621 is rotatably connected to the adjacent other mounting plate 1611.

In addition, as shown in FIG. 13, this embodiment fixes the spacing between the product boxes 110 via the connecting strips, which can effectively prevent issues such as shaking, misalignment, and derailment of the product boxes 110 within the closed bent slideway 123, reduce the occurrence of faults such as product jamming, motor overload, and damage of the product boxes 110, thereby lowering the probability of equipment failure, improving the operational reliability of the vending device 300, and reducing maintenance frequency.

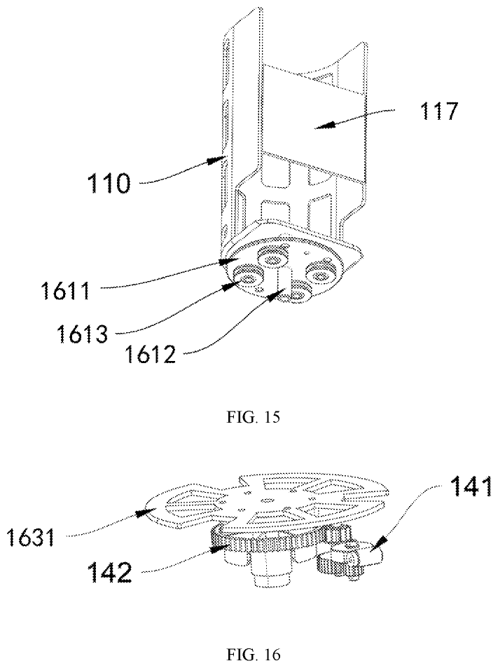

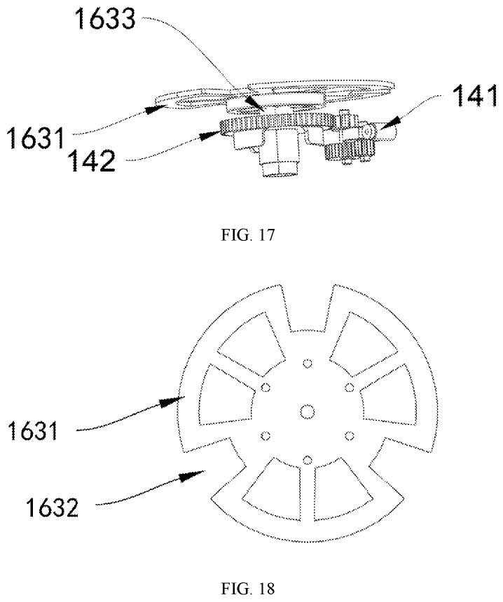

In an embodiment, as shown in FIG. 16 and FIG. 17, the tray 100 of this embodiment further includes a power assembly 140. The power assembly 140 is mounted on the mounting base 120, located on a side of the rotating member 163 facing away from the mounting members 161, and is configured to drive the rotating member 163 to rotate.

In an embodiment, as shown in FIG. 17 and FIG. 18, the rotating member 163 in this embodiment includes a rotary pulling piece 1631 and an insertion rod 1633.

Specifically, the rotary pulling piece 1631 in this embodiment is located on a side of the rollers 1613 facing away from the mounting plate 1611 and is disposed corresponding to the turning portion of the inner plate 122. The rotary pulling piece 1631 has three uniformly distributed engaging slots 1632 for engaging with the protrusion 1612 and driving the mounting member 161 and the product box 110 to slide along the closed bent slideway 123. Optionally, an engaging slot 1632 is defined every 120° on the rotary pulling piece 1631. When the rotary pulling piece 1631 rotates, it pushes the protrusions 1612 located in the three engaging slots 1632, thereby driving the mounting plates 1611 and the product boxes 110 corresponding to the three protrusions 1612 to move. The corresponding rollers 1613 also slide on the inner edge of the housing 121 and the outer edge of the inner plate 122, respectively.

In addition, the insertion rod 1633 is disposed between the rotary pulling piece 1631 and the power assembly 140. An end of the insertion rod 1633 is connected to the rotating pulling piece 1631, for example, by a threaded connection, and the other end of the insertion rod 1633 is in transmission connection with the power assembly 140.

In an embodiment, as shown in FIG. 16 and FIG. 17, the power assembly 140 in this embodiment includes a motor 141 and a transmission gear 142. The motor 141 is in transmission connection with the transmission gear 142. The insertion rod 1633 is, for example, inserted through a central hole of the transmission gear 142 and is in transmission connection with the transmission gear 142. The motor 141 is configured to drive the transmission gear 142 to drive the insertion rod 1633 and the rotating pulling piece 1631 to rotate.

In an embodiment, as shown in FIG. 9, FIG. 10 and FIG. 14, the tray 100 of this embodiment further includes a product retrieval frame 170 disposed at one end of the mounting base 120.

The product retrieval frame 170 has a product retrieval opening 173. The product retrieval opening 173 corresponds to the product box 110. An anti-theft blocking piece 171 extends toward the product retrieval opening 173 to form a product retrieval opening 173 that is narrow at the top and wide at the bottom. Specifically, the anti-theft blocking piece 171 in this embodiment forms an effective limiting function, thereby reducing the actual opening size of the product retrieval opening 173, preventing the user from reaching too deep during product retrieval and touching products behind the retrieval opening 173 that have not been dispensed.

In addition, a detector 172 is disposed on an end of the product retrieval frame 170 away from the mounting base 120. The detector 172 is configured to detect whether a product is present in the product box 110. In this embodiment, a quick response (QR) code is disposed on an inner bottom surface of each product box 110. The product box 110 in this embodiment has an uncovered top structure, i.e., no cover. When the product box 110 is transported to a position below the detector 172, the detector 172 can scan the QR code on its bottom directly from the top of the product box 110. When a product is placed in the product box 110, the QR code on its bottom is blocked by the product, and the detector 172 cannot scan the QR code, which indicates that the product box 110 contains a product. When the detector 172 can scan the QR code, it indicates that the product box 110 is empty. The information scanned by the detector 172 can be transmitted to prompt restocking.

In an embodiment, the product box 110 in this embodiment is, for example, a D-shaped box. An opening is defined on a flat side surface of the D-shaped product box 110 for taking out the product inside the product box 110. Optionally, in this embodiment, an elastic baffle 117 can be disposed on the opening of the D-shaped product box 110 to prevent the product from falling out and further prevent retrieval of undispensed products through the product retrieval opening 173, assisting in anti-theft. It should be noted that this embodiment does not limit the shape of the product box 110; the specific shape can be designed according to actual production requirements.

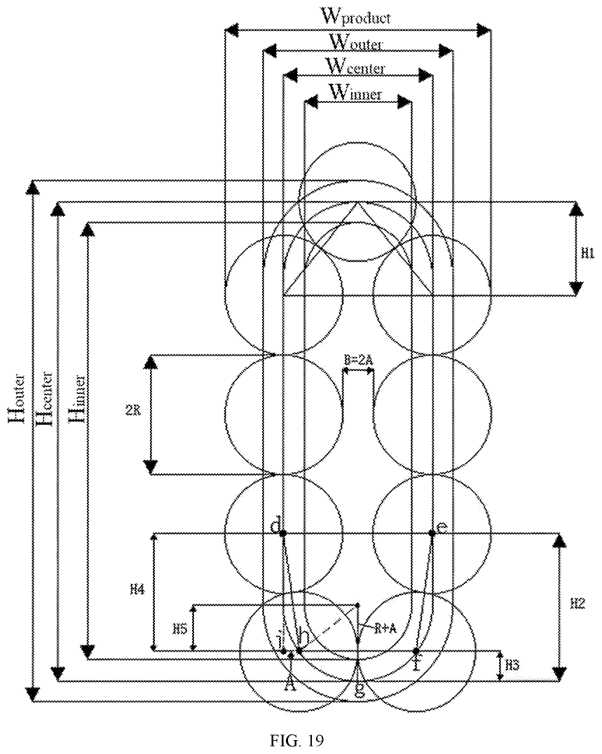

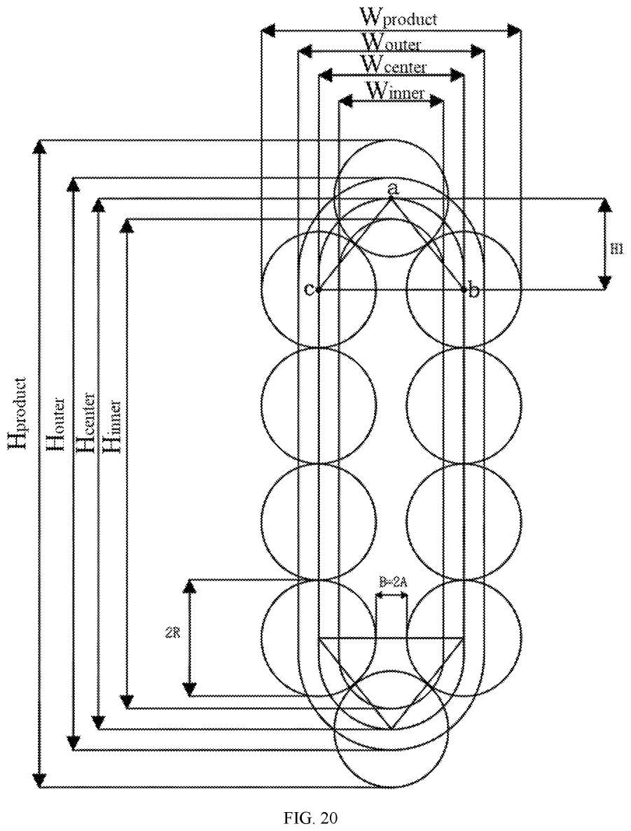

As shown in FIG. 14, FIG. 19 and FIG. 20, the closed bent slideway 123 includes linear sections 1231 and semi-circular sections 1232 disposed at two ends of the linear sections 1231. The closed bent slideway 123 is divided into an outer slideway, a slideway center line and an inner slideway. A radius of each product box 110 is R. A distance between two product boxes 110 respectively arranged back-to-back on the linear sections 1231 is 2A. A width of the closed bent slideway 123 is C. On each semi-circular section 1232, a radius of the outer slideway (i.e., the outer side of the semi-circular section 1232) is A+R+C/2, a radius of the slideway center line (i.e., the center line of the semi-circular section 1232) is A+R, and a radius of the inner slideway (i.e., the inner side of the semi-circular section 1232) is A+R−C/2.

As shown in FIG. 20, when an arrangement form of the product boxes 110 on the semi-circular section 1232 is an isosceles triangle, a distance from a center of a product box a to a center line connecting a center of a product box b and a center of a product box c adjacent to the product box a is H1. Referring to FIG. 19, when an arrangement form of the product boxes 110 on the semi-circular section 1232 is an isosceles trapezoid, a distance from a vertex g of the slideway center line to a center line connecting a center of a product box d and a center of a product box e respectively located on the linear sections 1231 is H2. A distance from a center line connecting a center of a product box h and a center of a product box f located on the semi-circular section 1232 to the vertex g of the slideway center line is H3. A distance from the center line connecting the center of the product box h and the center of the product box f located on the semi-circular section 1232 to the center line connecting the center of the product box d and the center of the product box e located on the line sections 1231 respectively is H4. A distance from the center line connecting the center of the product box h and the center of the product box f located on the semi-circular section 1232 to a center of the semi-circular section 1232 (i.e., a center of the rotating pulling piece 1631) is H5. Specifically, H1=\sqrt{4R²−(A+R)²}, H2=A+R+\sqrt{4R²−A²}−\sqrt{2 AR+A²}=H3+H4, H3=R+A+H5, H4=\sqrt{(4R)²−A²}, and H5=\sqrt{(R+A)²−R²}.

In practical operation, regardless of whether the arrangement form of the product boxes 110 on the semi-circular section 1232 is an isosceles triangle or an isosceles trapezoid, the arrangement form of the product boxes 110 at the end of the tray 100 facing the consumer for product retrieval is triangular, ensuring that at the retrieval point, only one product box 110 faces the consumer, as shown at the upper end of the tray schematic diagrams in FIG. 19 and FIG. 20.

A length of a movement trajectory of the product boxes 110 in the closed bent slideway 123 is H_{product}, a length of an outer side of the closed bent slideway 123 is Hₒᵤₜₑᵣ, a length of an inner side of the closed bent slideway 123 is Hᵢₙₙₑᵣ, and a length of a center line of the closed bent slideway 123 is H_{center}; and Hₒᵤₜₑᵣ=H_{center}+C, and Hᵢₙₙₑᵣ=H_{center}−C.

A width of the movement trajectory of the product boxes 110 in the closed bent slideway 123 is W_{product}, a width of the outer side of the closed bent slideway 123 is Wₒᵤₜₑᵣ, a width of the inner side of the closed bent slideway 123 is Wᵢₙₙₑᵣ, and a width of the center line of the closed bent slideway 123 is W_{center}; and Wₒᵤₜₑᵣ=2(A+R)+C, and Wᵢₙₙₑᵣ=2(A+R)−C.

When a number S of the product boxes 110 is an even number, both ends of the closed bent slideway 123 are arranged in a triangular pattern, and H_{center}=H1+H1+(S/2−2)×(2R).

When the number S of the product boxes 110 is an odd number, an end of the closed bent slideway 123 is arranged in an isosceles triangle, and the other end of the closed bent slideway 123 is arranged in an isosceles trapezoid, and H_{center}=H1+H2+((S−1)/2−2)×(2R).

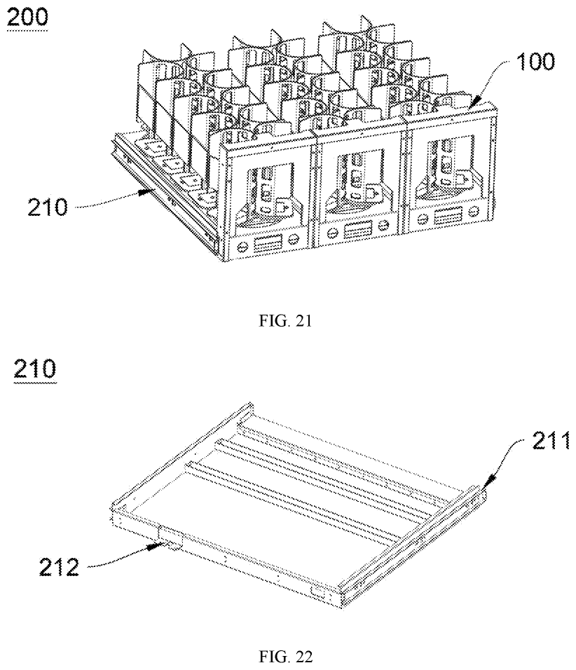

As shown in FIG. 21, this embodiment further provides a tray assembly 200. The tray assembly 200 includes multiple trays 100 described above, and thus has all the beneficial effects of the trays 100 described above, which will not be repeated here.

Specifically, as shown in FIG. 21 and FIG. 22, the tray assembly 200 in this embodiment includes multiple trays 100 and a tray bracket 210. The multiple trays 100 are sequentially connected and mounted on the tray bracket 210. Optionally, the number of trays 100 in this embodiment is, for example, three. The side surfaces of the housings 121 of the three trays 100 are sequentially connected by screws, and then the whole assembly is mounted on the tray bracket 210 by bolts. It should be noted that this embodiment does not limit the number of trays 100 on the tray assembly 200; the specific number can be designed according to actual production requirements.

As shown in FIG. 22, the tray bracket 210 includes movable rails 211. The movable rails 211 are mounted on two opposite sides of the tray bracket 210, i.e., a movable rail 211 is mounted on each of the left and right sides of the tray 100, and the two movable rails 211 are arranged parallel to each other. The two movable rails 211 are configured to be slidingly connected to an external structure, which facilitates the installation of the entire tray assembly 200 onto other external structures.

In an embodiment, an end of the tray bracket 210 facing away from the product retrieval frame 170 is provided with a lock head 212. The lock head 212 is, for example, an electric lock, used for locking the tray 100 in an external cabinet, and can be manually unlocked in the event of a power failure of the vending device 300.

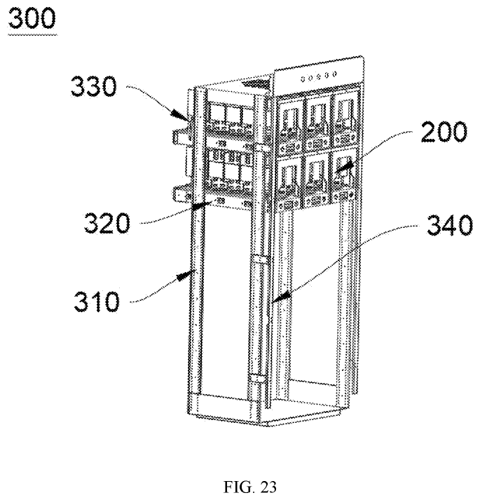

As shown in FIG. 23, this embodiment further provides a vending device 300. The vending device 300 includes the tray assembly 200 described above, and thus has all the beneficial effects of the tray 100 described above, which will not be repeated here.

Specifically, the vending device 300 includes multiple tray assemblies 200 and a frame. Optionally, this embodiment includes, for example, five tray assemblies 200. It should be noted that this embodiment does not limit the number of tray assemblies 200; the specific number can be designed according to actual production requirements.

The multiple tray assemblies 200 are sequentially disposed on the frame in a vertical direction. Each tray assembly 200 is slidably connected to the frame to form a pull-out structure.

Specifically, the frame includes four vertical columns 310 and fixed rails 320. The four vertical columns 310 are vertically and parallelly arranged. Each vertical column 310 defines multiple mounting holes for mounting the fixed rails 320. The fixed rails 320 are horizontally disposed on the vertical columns 310, and correspond to the movable rails 211 in a one-to-one manner, and the fixed rails 320 are in slidably cooperation with the movable rails 211, for mounting the tray assemblies 200.

In an embodiment, in this embodiment, two fixed rails 320 correspond to one tray assembly 200. The two fixed rails 320 are arranged parallel to each other, with one fixed rail 320 connected to two adjacent vertical columns 310, and the other fixed rail 320 connected to the other two adjacent vertical columns 310. This pair of fixed rails 320 are arranged opposite each other.

In an embodiment, as shown in FIG. 25, the vending device 300 further includes connecting rods 350, and the fixed rails 320 of the vending device 300 on the left and right are connected through the connecting rods 350. A lock catch is mounted on each connecting rod 350. When the tray assembly 200 slides back and forth on the fixed rails 320, the lock head 212 mounted on the tray bracket 210 can engage with the lock catch mounted on the connecting rod 350 for mating connection.

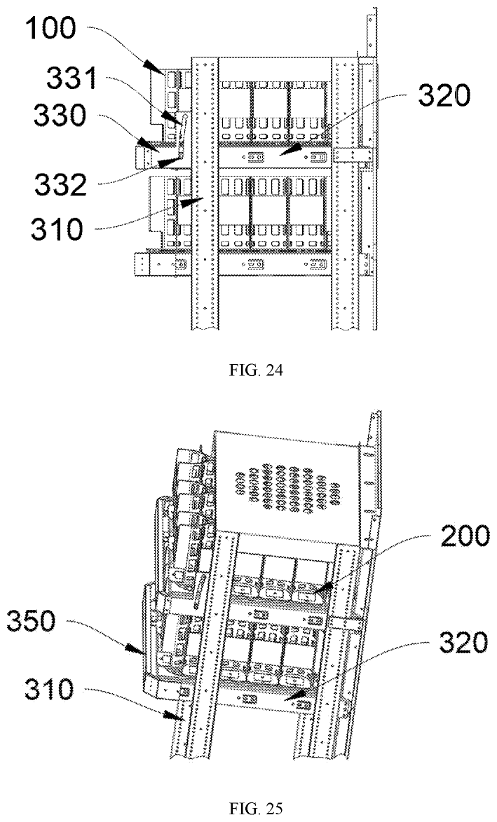

In an embodiment, as shown in FIG. 24, the vending device 300 in this embodiment further includes at least two adjustment plates 330. The two adjustment plates 330 are respectively disposed on two opposite vertical columns 310. Each adjustment plate 330 has a vertical sliding slot 331 and a sliding rod 332. One end of the sliding rod 332 is disposed in the sliding slot 331, and the other end of the sliding rod 332 is connected to an end of the fixed rail 320 facing away from the product retrieval frame 170, for raising one end of the fixed rail 320 and the tray assembly 200 to allow the tray assembly 200 to slide out in an inclined manner. It should be noted that when the end of the fixed rail 320 is provided with the adjustment plate 330, a front end of the fixed rail 320, i.e., the end close to the product retrieval frame 170, is rotatably connected to the vertical column 310 via a connecting rod passing through a mounting hole, so that the front end of the fixed rail 320 rotates downward synchronously as its rear end is raised, facilitating the sliding out of the tray assembly 200. If the tray assembly 200 is at a middle or low level, i.e., a height that is easy for staff to install, the fixed rails 320 for that layer can be fixedly connected to the vertical columns 310 by bolts passing through the mounting holes.

Specifically, when a tray 100 located at a higher position needs to be installed, the staff first uses the adjustment plates 330 to adjust the angle between the fixed rails 320 and the horizontal plane, so that the ends of the fixed rails 320 and the tray assembly 200 are raised. At this time, the tray assembly 200 slides out under the action of gravity, thereby reducing the difficulty of installing and removing tray assemblies 200 at higher levels, making it convenient for staff to restock the tray assemblies 200 at higher levels.

In an embodiment, as shown in FIG. 23, this embodiment further includes frame bars 340. The frame bars 340 are vertically mounted along the vertical columns 310 at the front ends of the fixed rails 320, i.e., the ends of the fixed rails 320 close to the product retrieval frame 170, for covering the front end cross-sections of the fixed rails 320 to maintain aesthetics.

It should be noted that in this embodiment, by arranging the multiple tray assemblies 200 on the frame, the multiple tray assemblies 200 can be mounted in different accommodating cabinets along with the frame. Moreover, the tray assemblies 200 are first mounted on the frame, and then the frame is placed into an external fully or partially enclosed space. This improves installation efficiency, making the frame with the multiple tray assemblies 200 flexible to install and highly adaptable to different installation sites.

In this embodiment, when the vending device 300 does not receive user usage information, the product retrieval opening 173 corresponds to the transition portion between two product boxes 110, i.e., the product boxes 110 do not directly correspond to the product retrieval opening 173. When a user uses the vending device 300, i.e., when the vending device 300 receives user usage information, the user selects one or more trays 100 for dispensing. The corresponding tray 100 responds, the power assembly 140 operates, driving the rotating pulling piece 1631 to rotate. The rotating pulling piece 1631 pushes the protrusion 1612 engaged in the slots, causing the corresponding mounting members 161 to slide, and the multiple mounting members 161 follow suit, eventually causing the opening of one product box 110 to align with the product retrieval opening 173. The detector 152 on the product retrieval frame 170 scans the inside of the product box 110. If a QR code is not scanned, dispensing can proceed normally. If a QR code is scanned, the device rotates further to bring a product box 110 containing a product to the product retrieval opening 173 for dispensing, and transmits the QR code scan information to the control platform to prompt restocking. When the opening of a product box 110 containing a product aligns with the product retrieval opening 173, the user can open the elastic baffle 117 to retrieve the product. After this retrieval is completed, the rotating pulling piece 1631 rotates again in the same direction so that the gap between the next product boxes 110 faces the product retrieval opening 173, thereby preventing a user from retrieving products without inputting usage information.

The above content is a detail description for the disclosure in conjunction with the embodiments, cannot be determined that the embodiments of the disclosure is limited to the description. Multiple simple deductions or substitutions can be made without departing from the concept of the disclosure for those skilled in the art.

What is claimed is:

1. A tray, comprising:
a plurality of product boxes, configured to store products;
a mounting base, provided with a closed bent slideway;
a transport assembly, comprising:
a plurality of mounting members, rotatably and sequentially disposed in the closed bent slideway in a circulating manner, wherein each of the plurality of mounting members is slidably connected to the mounting base, each of the plurality of product boxes is mounted on one side of a corresponding one of the plurality of mounting members, and the plurality of mounting members are arranged in one-to-one correspondence with the plurality of product boxes;
a plurality of connecting members, each disposed between two adjacent mounting members of the plurality of mounting members in the closed bent slideway, with two ends of the connecting member being rotatably connected to the two adjacent mounting members of the plurality of mounting members respectively, wherein the plurality of connecting members are configured to maintain a distance between the plurality of mounting members; and
a rotating member, disposed on the mounting base, wherein the rotating member is located on a side of the plurality of mounting members facing away from the plurality of product boxes, the rotating member is in transmission connection with the plurality of mounting members, and the rotating member is configured to drive the plurality of mounting members to rotate.

2. The tray as claimed in claim 1, wherein the mounting base comprises a housing and an inner plate, and the housing is disposed around the inner plate and forms the closed bent slideway together with the inner plate.

3. The tray as claimed in claim 1, wherein each of the plurality of mounting members comprises:
a mounting plate, configured to mount a corresponding one of the plurality of product boxes, wherein a protrusion is disposed on a side of the mounting plate facing away from the corresponding one of the plurality of product boxes, and the protrusion is configured to be in transmission connection with the rotating member; and
rollers, disposed on the side of the mounting plate facing away from the corresponding one of the plurality of product boxes, wherein the rollers are rotatably connected to the mounting plate, and slidably connected to an inner sidewall of the closed bent slideway.

4. The tray as claimed in claim 3, wherein each of the connecting members comprises a connecting strip, and two ends of the connecting strip define connecting holes respectively; the connecting holes are sleeved on protrusions of the two adjacent mounting members of the plurality of mounting members respectively; and a diameter of each of the connecting holes is greater than a diameter of an end of the protrusion close to the corresponding one of the plurality of product boxes, to make the protrusion being rotatably connected to the connecting strip.

5. The tray as claimed in claim 3, further comprising: a power assembly, mounted on the mounting base, wherein the power assembly is located on a side of the rotating member facing away from the plurality of mounting members, and is configured to drive the rotating member to rotate; and
wherein the power assembly comprises: a motor and a transmission gear; and the motor is in transmission connection with the transmission gear, the transmission gear is connected to the insertion rod, and the motor is configured to drive the transmission gear to drive the insertion rod and the rotary pulling piece to rotate.

6. The tray as claimed in claim 5, wherein the rotating member comprises:
a rotary pulling piece, having three uniformly distributed engaging slots; wherein the three engaging slots are configured to engage with the protrusion and drive the plurality of mounting members and the plurality of product boxes to slide along the closed bent slideway; and
an insertion rod, disposed between the rotary pulling piece and the power assembly, wherein an end of the insertion rod is connected to the rotary pulling piece, and the other end of the insertion rod is in transmission connection with the transmission gear.

7. The tray as claimed in claim 1, wherein a side surface of each of the plurality of product boxes defines an opening configured to take out the product inside the product box; an elastic baffle is disposed on the opening of the product box, the elastic baffle is rotatably connected to the product box, and is configured to prevent the product inside the product box from falling out and assist in anti-theft.

8. The tray as claimed in claim 7, further comprising: a product retrieval frame, disposed on an end of the mounting base;
wherein the product retrieval frame has a product retrieval opening corresponding to an opening of one of the plurality of product boxes close to the product retrieval opening, and an anti-theft blocking piece is disposed extending toward the product retrieval opening; and
wherein a detector is disposed on a side of the product retrieval frame facing away from the mounting base, and the detector is configured to detect whether a product is present in one of the plurality of product boxes located at the product retrieval opening.

9. The tray as claimed in claim 2, wherein the inner plate and the closed bent slideway are elliptical; and the rotating member is disposed corresponding to a turning portion of the inner plate.

10. The tray as claimed in claim 1, wherein the closed bent slideway comprises linear sections and semi-circular sections disposed at two ends of the linear sections; a radius of each of the plurality of product boxes is R, a distance between two of the plurality of product boxes respectively arranged back-to-back on the linear sections is 2A, and a width of the closed bent slideway is C; and
wherein a radius of an outer side of each of the semi-circular sections is A+R+C/2, and a radius of an inner side of each of the semi-circular sections is A+R−C/2.

11. The tray as claimed in claim 10, wherein a length of an outer side of the closed bent slideway is Hₒᵤₜₑᵣ, a length of an inner side of the closed bent slideway is Hᵢₙₙₑᵣ, and a length of a center line of the closed bent slideway is H_{center}; and Hₒᵤₜₑᵣ=H_{center}+C, and Hᵢₙₙₑᵣ=H_{center}−C;
wherein a width of the outer side of the closed bent slideway is Wₒᵤₜₑᵣ, a width of the inner side of the closed bent slideway is Wᵢₙₙₑᵣ, and a width of the center line of the closed bent slideway is W_{center}; and Wₒᵤₜₑᵣ=2(A+R)+C, and Wᵢₙₙₑᵣ=2(A+R)−C.

12. The tray as claimed in claim 10, wherein a number of the plurality of product boxes is S;
when S is an even number, an arrangement form of product boxes of the plurality of mounting members located on each of the semi-circular sections is a triangle, a distance from a center of a product box a to a center line connecting a center of a product box b adjacent to the product box a and a center of a product box c adjacent to the product box a is H1; and H_{center}=H1+H1+(S/2−2)×(2R).

13. The tray as claimed in claim 10, wherein a number of the plurality of product boxes is S;
when S is an odd number, an arrangement form of product boxes of the plurality of product boxes located on one of the semi-circular sections is an isosceles triangle, and an arrangement form of product boxes of the plurality of product boxes located on the other of the semi-circular sections is an isosceles trapezoid;
when the arrangement form is the isosceles triangle, a distance from a center of a product box a to a center line connecting a center of a product box b adjacent to the product box a and a center of a product box c adjacent to the product box a is H1; and
when the arrangement form is the isosceles trapezoid, a distance from a vertex g of a center line of the other one of the semi-circular sections to a center line connecting a center of a product box d and a center of a product box e respectively located on the linear sections is H2; and H_{center}=H1+H2+((S−1)/2−2)×(2R).

14. A tray assembly, comprising the tray as claimed in claim 1, wherein the tray is multiple in quantity, and the tray assembly further comprises:
a tray bracket, wherein the multiple trays are mounted on the tray bracket in sequence, and the tray bracket comprises movable rails, mounted on two opposite sides of the tray frame, and configured to be slidingly connected to an external structure.

15. A vending device, comprising the tray assembly as claimed in claim 14, wherein the tray assembly is multiple in quantity, and the vending device further comprises a frame, the multiple tray assemblies are disposed on the frame in sequence along a vertical direction, and each of the multiple tray assemblies is slidably connected to the frame to form a pull-out structure.

16. The vending device as claimed in claim 15, wherein the frame comprises four vertical columns and fixed rails; and
wherein the four vertical columns are vertically and parallelly arranged, each of the four vertical columns defines a plurality of mounting holes, and the plurality of mounting holes are configured to mounting the fixed rails; and the fixed rails are horizontally disposed on the four vertical columns, the fixed rails correspond to the movable rails in an one-to-one manner, and are in slidably cooperation with the movable rails, and the fixed rails are configured to mount the multiple tray assemblies.

17. The vending device as claimed in claim 16, further comprising: at least two adjustment plates respectively disposed on two opposite vertical columns of the four vertical columns, wherein each of the at least two adjustment plates defines a vertical sliding slot and is provided with a sliding rod, an end of the sliding rod is disposed in the vertical sliding slot, and the other end the sliding rod is connected to an end of a corresponding one of the fixed rails facing away from a product retrieval frame, the at least two adjustment plates are configured to raise the end of the corresponding one of the fixed rails and an end of a corresponding one of the multiple tray assemblies to allow the corresponding one of the multiple tray assemblies to slide out in an inclined manner.
